(19) United States
(12) Patent Application Publication
(10) Pub. No.: US 2019/0224576 A1
(43) Pub. Date: Jul. 25, 2019

(54) SYSTEM AND METHOD FOR THE ENCOURAGEMENT OF CUSTOMER VISITS TO RETAIL STORES

(71) Applicant: Walmart Apollo, LLC, Bentonville, AR (US)

(72) Inventors: Kun Cheng, Salt Lake City, UT (US); Gabriel Tyrone Ford, Salt Lake City, UT (US); Jarom Norris, Salt Lake City, UT (US); Jacob Pandian, Minneapolis, MN (US)

(21) Appl. No.: 16/243,773

(22) Filed: Jan. 9, 2019

Related U.S. Application Data
(60) Provisional application No. 62/621,965, filed on Jan. 25, 2018.

(51) Int. Cl. A63F 13/847; G06Q 30/06; G06Q 30/02; A63F 13/65

(52) U.S. Cl. CPC A63F 13/847; A63F 13/65; G06Q 30/0226; G06Q 30/0635

(57) ABSTRACT

A current version of the electronic representation of the building or physical fabrication is received at a mobile electronic device. Sales data of products purchased by the customer is collected at the home retail store using a sensor, and based upon the collected sales data, awards are assigned to the customer. The customer purchases of one or more electronic building elements using the awards. As directed by customer input, a modified electronic representation of the building or physical fabrication is formed including the purchased one or more electronic building elements. The modified electronic representation of the building or physical fabrication is uploaded to a central processing center for sharing with and modifying by other customers.

### CROSS-REFERENCE TO RELATED APPLICATION

This application claims the benefit of the following U.S. Provisional Application No. 62/621,965 filed Jan. 25, 2018, which is incorporated herein by reference in its entirety.

### TECHNICAL FIELD

These teachings relate to approaches that encourage customers to physically visit retail stores and, more specifically, to electronic computer games that are played cooperatively amongst multiple users and that encourage foot traffic into these stores.

### BACKGROUND

Retail stores sell a variety of different types of products. These products are sometimes sold over the internet as well. The use of on-line ordering has been increasing in recent years.

Retail stores rely on foot traffic (actual customer visits) for a significant portion of their sales. When a customer (or potential customer) visits a store seeking to purchase a specific product, they often end up purchasing other products that they initially had no interest. By physically visiting the retail store, a customer may end up purchasing more than they originally intended, thereby increasing sales in the store.

However, the increased use of the internet for on-line ordering of products has decreased actual customer visits to stores in some situations. This, in turn, has decreased store sales and store profits.

### BRIEF DESCRIPTION OF THE DRAWINGS

The above needs are at least partially met through electronic gaming approaches that encourage customer visits to retail stores, particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings;

FIG. 4 comprises a diagram of a system as configured in accordance with various embodiments of these teachings;

FIG. 5 comprises a diagram of a system as configured in accordance with various embodiments of these teachings.

### DETAILED DESCRIPTION

Generally speaking, a user registers to play a computer game at their “home” retail store. The computer game involves cooperatively building a structure such as a castle with other players of the game. To participate, the customer purchases building elements for use in constructing the structure. In one example, the customer scans their sales receipt to obtain the rewards, which can be redeemed in purchasing the building elements. Once purchased, these new building elements are added to the electronic representation to the structure as instructed by the customer. As mentioned, the structure is shared with other customers, who can add still more building elements or change the configuration of the existing building elements. The game is structured and presented so as to be fun and entertaining for customers to play.

The customer can also visit “non-home” stores and engage or participate in other aspects of the game. For example, the customer can travel to a non-home store and attempt to tear down a structure, such as a castle. Since the customer has to physically be present at the store to play the game, customer visits to stores are encouraged, foot traffic to the store is increased, and store sales are also increased.

In many of these embodiments, a system for encouraging customers to travel to and shop at retail stores includes a central processing center or server, a data storage device, and a mobile electronics device.

The data storage device stores an electronic representation of a building or physical fabrication constructed by humans. The building or physical fabrication is constructed of multiple electronic building elements purposely and cooperatively arranged by multiple customers to form the building or physical fabrication.

The mobile electronic device is in communication with the central processing center and the data storage device and includes a control circuit, a user interface, and a sensor. The control circuit is configured to facilitate a registration for a customer at the central processing center as a team member of a home retail store. The control circuit is further configured to receive a current version of the electronic representation of the building or physical fabrication after completion of the registration.

The sensor is configured to collect sales data of products purchased by the customer at the home retail store, and based upon the collected sales data, assign awards to the customer.

The user interface is configured to receive purchase requests from the customer to purchase one or more electronic building elements using the awards.

The control circuit, as directed by customer input received via the user interface, forms a modified electronic representation of the building or physical fabrication including the purchased one or more electronic building elements. The control circuit uploads the modified electronic representation of the building or physical fabrication to the central processing center for sharing with and modifying by other customers.

In aspects, the customer travels to another non-home retail store and purchases a destructive electronic element using the awards via the user interface, and obtains an electronic representation of a second building or physical fabrication associated with the non-home store. The control circuit, as directed by user input received via the user interface, forms a modified electronic representation of the second building or physical fabrication by applying the purchased destructive electronic element to the electronic representation of the second building or physical fabrication. The control circuit uploads the modified electronic representation of the second building or physical fabrication to a second central processing center for sharing with other customers at the non-home store. In examples, the destructive electronic elements are electronic representations of bombs or explosives.

In other aspects, the electronic building elements are electronic representations of blocks or other types of building components. In examples, the awards are points. Other types of building elements and awards are possible.

In other examples, the mobile electronic device is a smartphone, a laptop, a tablet, or a personal computer. Other examples of devices are possible.

In yet other examples, the customer is a team member of one team of a plurality of teams. The teams compete across multiple retail stores to accumulate the most points.

In still other examples, the building or physical fabrication is a castle. Other structures such as houses, high-story buildings, and bridges are possible.

In others of these embodiments, an electronic representation of a building or physical fabrication constructed by humans is stored at a data storage device. The building or physical fabrication is constructed of multiple electronic building elements purposely arranged by multiple customers to form the building or physical fabrication.

Communications are made with a central processing center to obtain a registration for a customer as a team member of a home retail store. The team member may be utilizing a mobile electronic device. A current version of the electronic representation of the building or physical fabrication is received at the mobile electronic device upon completion of the registration. Sales data of products purchased by the customer is collected at the home retail store using a sensor (e.g., disposed at the mobile electronic device), and based upon the collected sales data, awards are assigned to the customer.

Purchase requests of the customer are accepted at a user interface (e.g., of the mobile electronics device) for purchases of one or more electronic building elements using the awards. As directed by customer input received via the user interface, a modified electronic representation of the building or physical fabrication is formed including the purchased one or more electronic building elements. The modified electronic representation of the building or physical fabrication is uploaded to the central processing center for sharing with and modifying by other customers.

In others of these embodiments, a system for encouraging customers to travel to and shop at retail stores includes a home retail store, shelving or display units disposed in the retail store, products disposed on the shelving or display units (and the products include identifiers), a central processing center or server, a data storage device, and a mobile electronics device.

The data storage device stores an electronic representation of a building or physical fabrication constructed by humans. The building or physical fabrication is constructed of multiple electronic building elements purposely and cooperatively arranged by multiple customers to form the building or physical fabrication.

The mobile electronic device is in communication with the central processing center and the data storage device. The mobile electronic device includes a control circuit, a user interface, and a sensor. The control circuit is configured to facilitate a registration for a customer at the central processing center as a team member of the home retail store. The control circuit is further configured to receive a current version of the electronic representation of the building or physical fabrication after completion of the registration.

The sensor is configured to collect sales data of products purchased by the customer at the home retail store by scanning the identifiers on the products or identifiers on a sales receipt. The control circuit is configured to based upon the collected sales data, assign awards to the customer.

The user interface is configured to receive purchase requests from the customer to purchase one or more electronic building elements using the awards. The control circuit, as directed by customer input received via the user interface, is configured to form a modified electronic representation of the building or physical fabrication including the purchased one or more electronic building elements.

The control circuit uploads the modified electronic representation of the building or physical fabrication to the central processing center for sharing with and modifying by other customers. The modified electronic representation is transmitted from the central processing center to electronic user devices of the other users and at least some of the other users further alter the modified electronic representation.

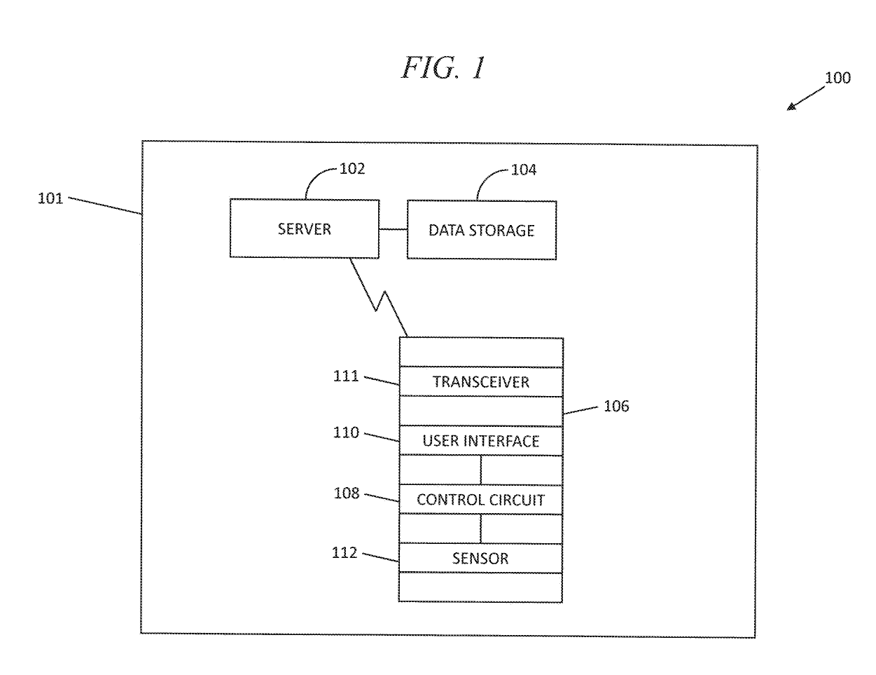

Referring now to FIG. 1, one example of a system 100 at a home retail store 101 that encourages customer visits to retail stores is described. The system 100 includes a central processing center or server 102, a data storage device 104, and a mobile electronics device 106.

In aspects, the central processing center or server 102 is disposed at the retail store 101. Alternatively, the central processing center or server 102 may be disposed at an external location such as a company headquarters. The server 102 is any combination of electronic hardware and software (e.g., a computer that executes programmed instructions). The retail store 101 includes shelving or display units that present products for purchase by customers. The shelving or display units can be any type of structure that presents products to customers. The products can be any type of products.

The data storage device 104 is any type of memory storage device. The data storage device 104 stores an electronic representation of a building or physical fabrication constructed by humans. The building or physical fabrication is constructed of multiple electronic building elements purposely and cooperatively arranged by multiple customers to form the building or physical fabrication. The electronic representation may be structured according to any file format, data structure, or data storage protocol. In still other examples, the building or physical fabrication is a castle.

The mobile electronic device 106 is any type of device such as a smartphone, a personal computer, a tablet, a cellular phone, or a laptop computer. Other examples of mobile electronic devices are possible. The mobile electronic device 106 is in communication with the central processing center 102 and the data storage device 104 and includes a control circuit 108, a user interface 110, a transceiver 111, and a sensor 112.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is configured to facilitate a registration for a customer at the central processing center as a team member of a home retail store. The control circuit 108 is further configured to receive a current version of the electronic representation of the building or physical fabrication after completion of the registration. To register, a customer may enter information (e.g., login information including a username and a password) via the interface 110. The “home” retail store may be a single store where the customer does the largest percentage of their shopping (as compared to other stores), is most convenient (e.g., geographically the closest) to the customer, and/or the store where the customer prefers to join a particular team of other customers in playing the game. A “non-home” store is any store that is not the home store of the customer. It will be appreciated that a customer will typically have a single home store, but in other cases may have or be associated with multiple home stores (i.e., join multiple teams of players in multiple stores).

The sensor 112 is any type of device that is capable of obtaining or sensing sales information. In one example, the sensor 112 is an electronic scanner. In aspects, the sensor 112 is configured to collect sales data of products purchased by the customer at the home retail store, and based upon the collected sales data, assign awards to the customer. In one example, the sensor 112 scans sales data, item numbers, and other information or identifiers from the receipt. In another example, the products include identifiers (e.g., paper tags or electronic tags) and the sensor 112 scans these tags. The control circuit 108 processes this information using algorithms well-known to those skilled in the art that convert the scanned information into digital information, and recognize the information. As described elsewhere herein, the control circuit 108 may then (once the sales information has been recognized) assign rewards or points to the customer. Alternatively, the sales information may be sent to the server 102, which evaluates the information, assigns points, and communicates the points to the mobile electronics device 106.

Although the sales information may be scanned from sales receipts or from the product by the customer, it will be appreciated that it may be obtained in other ways as well. For example, as the customer checks out at a sales register, the information may be collected automatically (e.g., using cameras or other sensors at the sales register area) or by a clerk (e.g., who scans the product, for instance, using a hand-held scanner or by directing the product to a scanner at the sales register area). This information is then sent to the server 102, which assigns points (or other types of rewards indicators). These points may be communicated to the mobile electronic device 106. It will also be understood that rewards or points may be accumulated in other ways besides through product purchases. For example, a customer may be awarded points for visiting the retail store.

The user interface 110 is any type of device that can render information to a user, and/or obtain information from a user. In examples, the user interface 110 is or includes any combination of a touchscreen, a keypad, a screen, and a computer mouse. Other examples of user interfaces are possible. The user interface 110 is configured to receive purchase requests from the customer to purchase one or more electronic building elements using the awards. In aspects, the electronic building elements are electronic representations of blocks. In examples, the awards are points. The transceiver 111 is configured to allow the device 106 to communicate with the server.

The control circuit 108, as directed by customer input received via the user interface 110, forms a modified electronic representation of the building or physical fabrication including the purchased one or more electronic building elements. The control circuit 108 uploads the modified electronic representation of the building or physical fabrication to the central processing center 102 for sharing with and modifying by other customers. It will be appreciated that this centralized architecture of storing an up-to-date electronic representation at a central location accessible to multiple users is advantageous since it allows the efficient sharing of the modified electronic representation amongst multiple players. The central processing center 102 may be in the store (i.e., each store has its own electronic building representation stored at its own server), or may be at some remote location (e.g., a headquarters where an electronic representation of a building is shared between multiple stores).

In other aspects, the customer travels to another non-home retail store 114 and purchases a destructive electronic element using the awards via the user interface 110. The customer then obtains an electronic representation of a second building or physical fabrication associated with the non-home store via the transceiver 111. The control circuit 108, as directed by user input received via the user interface 110, forms a modified electronic representation of the second building or physical fabrication by applying the purchased destructive electronic element to the electronic representation of the second building or physical fabrication. For example, destructive elements (e.g., dynamite, bricks, or bombs) may be tossed by the user at the second building or physical fabrication. The control circuit 108 uploads the modified electronic representation of the second building or physical fabrication to a second central processing center 114 for sharing with other customers at the non-home store.

In yet other examples, the customer is a team member of one team of a plurality of teams, and the teams compete across multiple retail stores to accumulate the most team points. A prize or prizes may be purchased with the team points. In some other examples, a donation by the store may be made to a team's choice of a charity for the team that accumulates the most team points. It will be appreciated that there are two different kinds of points: individual points (gained or obtained by individual customers by purchasing products), and team points (gained or obtained by team members through, for example, building, destroying, or playing the game, and not through purchasing products, where team points of individual members are accumulated into a total team point score)

In one particular example, one or more members of a team travels to a non-home store. The team member logs into (or registers with) the server at the non-home store. The team member then “attacks” the structure (e.g., a castle) hosted by the server at the non-home store. Team points are assigned based upon the results (e.g., the relative success) of the “attack.” For example, a certain number of team points are assigned for knocking down or dislodging portions of the structure. The larger the dislodgment, the greater number of points assigned.

In other examples, home team members can earn team points by “defending” their home structure (e.g., a castle) from attacks. In examples, both home and non-home members can interact simultaneously with each other when an “attack” by non-home store members on a structure occurs.

In other aspects, the rewards and prizes can be redeemed in a variety of different ways. For example, the rewards and prizes may be redeemed by submitting an electronic form. The electronic from may be submitted to a reward processing device (e.g., a control circuit), which forms control signals that control an automated vehicle (e.g., an automated ground vehicle or aerial drone) or robot to retrieve a reward (e.g., a product from the shelves of the store) and deliver it to the customer (e.g., either in the store or at a location external to the store).

It will be appreciated that as described herein, the electronic representation of a building is modified and physically transformed. That is, multiple customers, by their actions physically change this representation. In aspects, a data structure that is utilized to represent the building is physically transformed. The physical transformation of the data structure, in examples, may change the size, layout, and/or contents of the data structure.

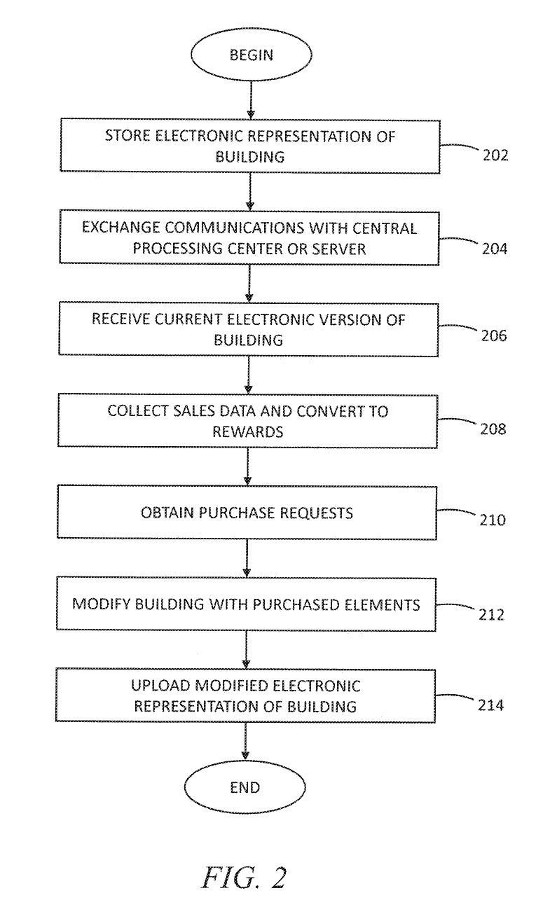

Referring now to FIG. 2, one example of an approach for increasing customer visits to a retail store is described. In this example, a customer desires to play the game on a portable electronic device such as a smartphone, tablet, personal computer, or laptop, which the customer brings to a retail store.

At step 202, an electronic representation of a building or physical fabrication constructed by humans is stored at a data storage device. The building or physical fabrication is constructed of multiple electronic building elements purposely arranged by multiple customers to form the building or physical fabrication.

At step 204, communications are made or exchanged with a central processing center or server to obtain a registration for a customer as a team member of a home retail store. Once the registration is obtained, the customer may login to play the game, for example, by entering their username and password.

At step 206, a current version of the electronic representation of the building or physical fabrication is received at the mobile electronics device upon completion of the registration (or the log-in) process.

At step 208, sales data of products purchased by the customer is collected at the home retail store using a sensor, and based upon the collected sales data, awards are assigned to the customer. In one example, the mobile electronics device has a scanner, which is used by the customer to scan a paper sales receipt. In other examples, the sales register scans the information (e.g., when the customer is checking out and paying for their items), and communicate that information to the mobile electronics device (or a server).

The rewards may be in the form of points. For example, a one-to-one (or other direct type of) correspondence between dollar value of purchased items and points may be determined (e.g., a $100 purchase may result in 100 points being assigned). In other example, certain products or services, when purchased, may have a higher relative point value than other products or services (e.g., purchasing certain food items may result in double the normal amount of points being assigned). Points may also be increased during certain periods of time such as certain days of the week or certain times of day. As described elsewhere herein, the customer may also obtain another type of points (team points) by playing the game.

At step 210, purchase requests of the customer are accepted at a user interface for purchases of one or more electronic building elements using the awards. In one example, the electronic building elements are blocks. Based upon the number of points a customer has accumulated, the customer purchases one or more of the blocks.

At step 212, and as directed by customer input received via the user interface, a modified electronic representation of the building or physical fabrication is formed including the purchased one or more electronic building elements. For example, the customer moves their blocks and adds the blocks to the structure, forming new structures. The modification to the existing structures, in one example, is accomplished by electronic computer instructions executed at a control circuit.

At step 214, the modified electronic representation of the building or physical fabrication is uploaded to the central processing center for sharing with and modifying by other customers. In examples, the other customers access and play the game in the same way as has been described. The server may be structured to reconcile the changes made to the electronic representation of the building or physical fabrication by various customers that are simultaneous customers that are playing the game. In one particular example, customers are given the latest version of the building. As each customer returns a modified structure to the server, the changes are made. In another example, only one customer is allowed to play the game at a time. In still another example, particular customers may be given priority levels allowing a particular customer precedence in changing a structure (as compared to other customers). That is, higher priority or higher ranked customers are allowed to play the game before other, lower ranked customers.

In still other aspects, a reconciliation process may be used to modify the electronic representation at the central processing center when multiple customers are simultaneously playing the game. This reconciliation process may, in one example, identify changes to the building as these changes arrive from individual customers and apply the latest changes to the building. The changes of higher priority customers may take precedence when there is a conflict (e.g., one customer has kept a building block, while another customer has removed a building block). Non-conflicting changes may be added to the structure.

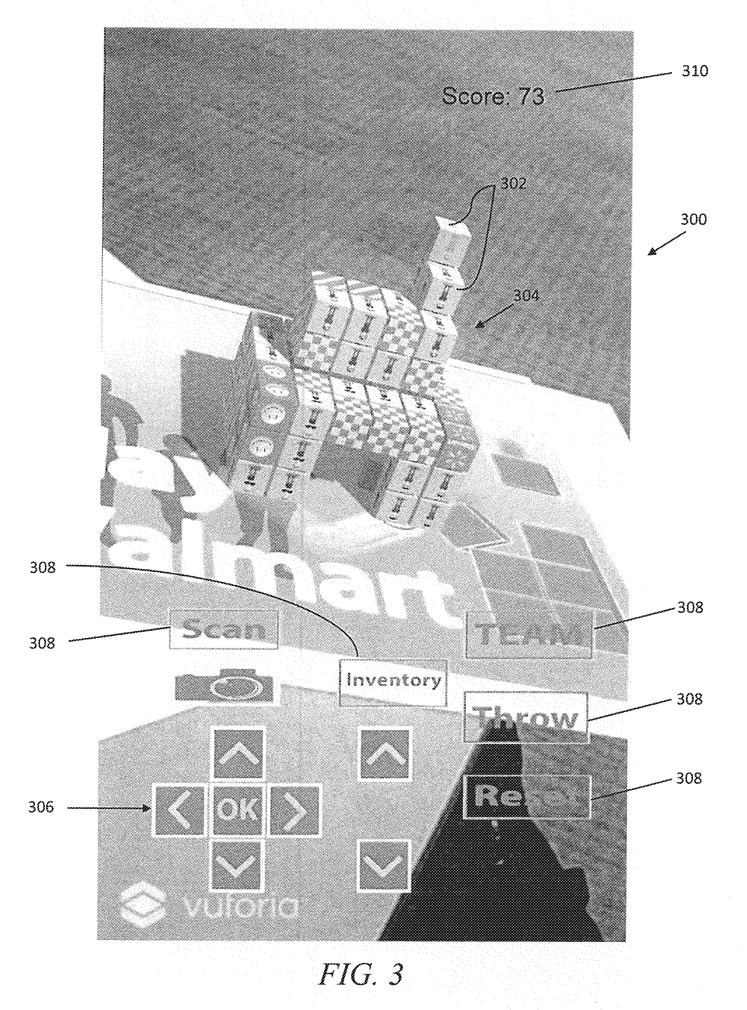

Referring now to FIG. 3, one example of a screen or screen-shot 300 for a computer game is described. The screen 300 shows a structure that is being built or has been built. Electronic blocks 302 (two are labeled for simplicity) are assembled into an electronic structure 304. User controls 306 can be used to move blocks into position, change the field of view, change the orientation or angle of view, and perform other functions. Keys 308 may be used for various functions such as throwing blocks into structures (e.g., when attacking a castle at a non-home store), resetting the game, scanning a sales receipt, showing team information, or showing an inventory of available building elements. A score 310 may indicate points obtained by the customer that can be used as team points.

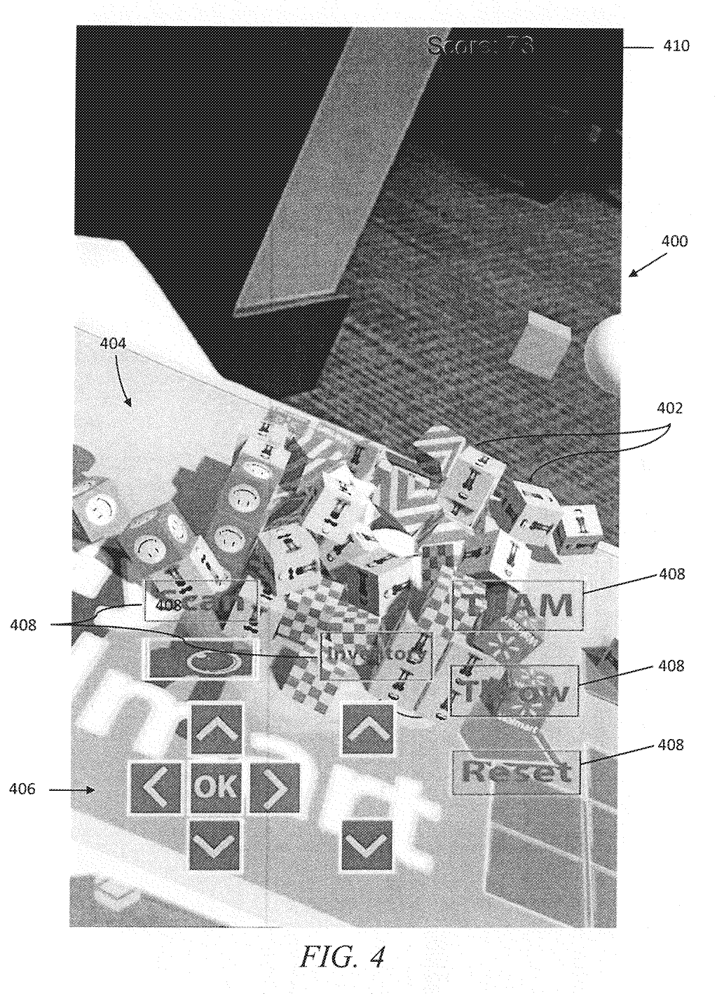

Referring now to FIG. 4, another example of a screen or screen-shot 400 for a computer game is described. The screen 400 shows a structure that has been torn down or destroyed. In this example, a block has been thrown into a structure 304 that was built of blocks 302. The “attack” results in the structure 304 collapsing.

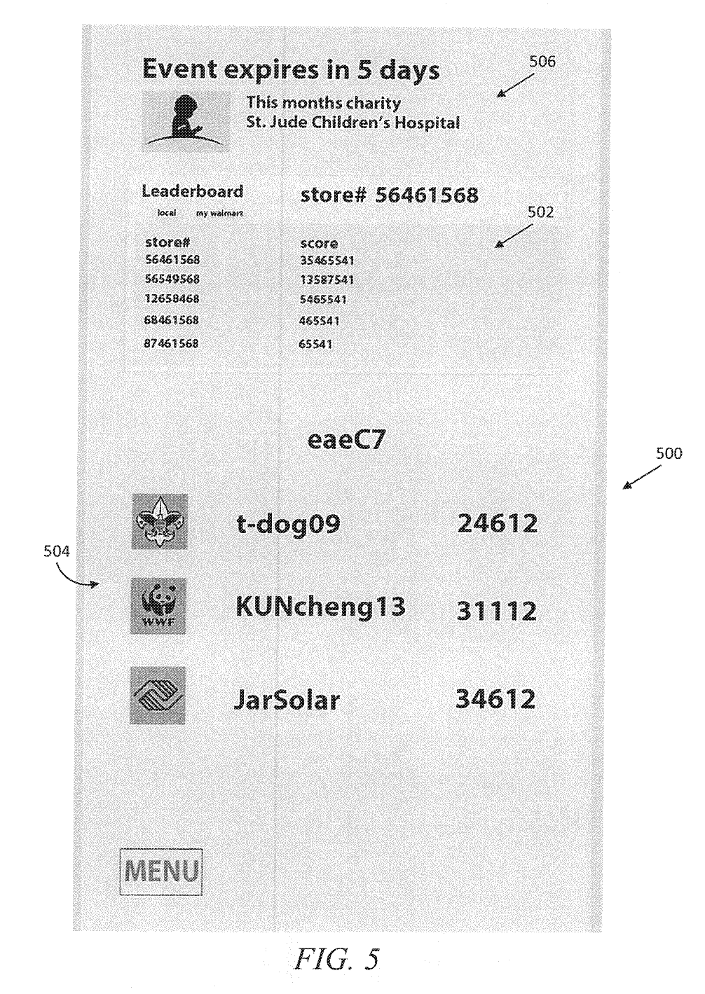

Referring now to FIG. 5, another example of a screen or screen-shot 500 for a computer game is described. This screen 500 is an information screen. A first section 502 of the screen is a leaderboard showing team points accumulated at different stores (and a leader, which is store 56461568). A second section 504 includes individual leaders. A third section 506 shows a charity event for which the various teams (with each store having a team) are competing.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system for encouraging customers to travel to and shop at retail stores, the system comprising:
a home retail store;
shelving or display units disposed in the retail store;
products disposed on the shelving or display units, the products including identifiers;
a central processing center or server;
a data storage device that stores an electronic representation of a building or physical fabrication constructed by humans, the building or physical fabrication being constructed of multiple electronic building elements purposely and cooperatively arranged by multiple customers to form the building or physical fabrication;
a mobile electronic device in communication with the central processing center and the data storage device, the mobile electronic device including a control circuit, a user interface, and a sensor, the control circuit configured to facilitate a registration for a customer at the central processing center as a team member of the home retail store, the control circuit further configured to receive a current version of the electronic representation of the building or physical fabrication after completion of the registration;
wherein the sensor is configured to collect sales data of products purchased by the customer at the home retail store by scanning the identifiers on the products or identifiers on a sales receipt, and wherein the control circuit is configured to based upon the collected sales data, assign awards to the customer;
wherein the user interface is configured to receive purchase requests from the customer to purchase one or more electronic building elements using the awards;
wherein the control circuit, as directed by customer input received via the user interface, forms a modified electronic representation of the building or physical fabrication including the purchased one or more electronic building elements;
wherein the control circuit uploads the modified electronic representation of the building or physical fabrication to the central processing center for sharing with and modifying by other customers;
wherein the modified electronic representation is transmitted from the central processing center to electronic user devices of the other users and at least some of the other users further alter the modified electronic representation.

2. The system of claim 1, wherein the customer travels to another non-home retail store and purchases a destructive electronic element using the awards via the user interface, and obtains an electronic representation of a second building or physical fabrication associated with the non-home store;
wherein the control circuit, as directed by user input received via the user interface, forms a modified electronic representation of the second building or physical fabrication by applying the purchased destructive electronic element to the electronic representation of the second building or physical fabrication;
wherein the control circuit uploads the modified electronic representation of the second building or physical fabrication to a second central processing center for sharing with other customers at the non-home store.

3. The system of claim 2, wherein the destructive electronic elements are electronic representations of bombs or explosives.

4. The system of claim 1, wherein the electronic building elements are electronic representations of blocks.

5. The system of claim 1, wherein the awards are individual points.

6. The system of claim 1, wherein the mobile electronic device is a smartphone, a laptop, a tablet, or a personal computer.

7. The system of claim 1, wherein the customer is a team member of one team of a plurality of teams, and the teams compete across multiple retail stores to accumulate the most team points.

8. The system of claim 1, wherein the building or physical fabrication is a castle.

9. A method for encouraging customers to travel to and shop at a retail store, the method comprising:
at home retail store that includes shelving or display units, disposing products on the shelving or display units, the products including identifiers;
storing an electronic representation of a building or physical fabrication constructed by humans at a data storage device, the building or physical fabrication being constructed of multiple electronic building elements purposely arranged by multiple customers to form the building or physical fabrication;
communicating with a central processing center to obtain a registration for a customer as a team member of a home retail store;
receiving a current version of the electronic representation of the building or physical fabrication upon completion of the registration;
collecting sales data of products purchased by the customer at the home retail store using a sensor to scan the identifiers on the products or identifiers on a sales receipt, and based upon the collected sales data, assigning awards to the customer;
accepting purchase requests of the customer at a user interface for purchases of one or more electronic building elements using the awards;
as directed by customer input received via the user interface, forming a modified electronic representation of the building or physical fabrication including the purchased one or more electronic building elements;
uploading the modified electronic representation of the building or physical fabrication to the central processing center for sharing with and modifying by other customers;
wherein the modified electronic representation is transmitted to electronic user devices of the other users and at least some of the other users further alter the modified electronic representation.

10. The method of claim 9, wherein the customer travels to another non-home retail store and purchases a destructive electronic element using the awards via the user interface, and obtains the electronic representation of a second building or physical fabrication associated with the non-home store;
wherein the control circuit, as directed by user input received via the user interface, forms a modified electronic representation of the second building or physical fabrication by applying the purchased destructive element to the electronic representation of the second building or physical fabrication;
wherein the control circuit uploads the modified electronic representation of the second building or physical fabrication to a second central processing center for sharing with other customers at the non-home store.

11. The method of claim 10, wherein the destructive electronic elements are electronic representations of bombs or explosives.

12. The method of claim 9, wherein the building elements are electronic representations of blocks.

13. The method of claim 9, wherein the awards are individual points.

14. The method of claim 9, wherein the mobile electronic device is a smartphone, a laptop, a tablet, or a personal computer.

15. The method of claim 9, wherein the customer is a team member of one team of a plurality of teams, and the teams compete across multiple retail stores to accumulate the most team points.

16. The method of claim 9, wherein the building or physical fabrication is a castle.
